(19) United States
(12) Patent Application Publication
(10) Pub. No.: US 2022/0105613 A1
(43) Pub. Date: Apr. 7, 2022

(54) LOCKING SLEEVE

(71) Applicant: HUNG-I HSU, KAOHSIUNG CITY (TW)

(72) Inventor: HUNG-I HSU, KAOHSIUNG CITY (TW)

(21) Appl. No.: 17/064,746

(22) Filed: Oct. 7, 2020

(51) Int. Cl. B25B 27/14

(52) U.S. Cl. CPC B25B 27/143

(57) ABSTRACT

A locking sleeve includes an inner sleeve and an outer sleeve sleevedly disposed thereon. The inner sleeve has an inner body and a shank extending outwards from the inner body. The outer sleeve has an outer body where an engagement space is enclosed and opposite first and second ends are respectively defined and a plurality of slots cutting into the outer body and extending from the second end to divide the outer body into a plurality of clamping portions with elasticity. Each clamping portion has an engagement unit formed on an edge thereof. When a head of a fastening unit is situated in the engagement space, the engagement units clamp and engage the head so that the fastening unit is quickly and firmly positioned to facilitate the following fastening operation, and the locking sleeve is more convenient to use.

### BACKGROUND OF THIS INVENTION

### 1. Field of this Invention

This invention relates to a locking tool and relates particularly to a locking sleeve.

### 2. Description of the Related Art

With the development of industrial technology, fastening units such as bolts, nuts and screws are commonly used in the assembly and disassembly of various products, and locking sleeves are widely used in the assembly and disassembly of the fastening unit with a hexagonal head. However, different hexagonal heads have different dimensional tolerances. In order that the locking sleeve can be adapted to the hexagonal heads with different dimensional tolerances, an engagement space formed inside the locking sleeve has a large tolerance, and that causes the locking sleeve is unable to fix the hexagonal heads of different fastening units tightly. Thus, larger force is required to be applied on the locking sleeve in order to firmly press and position the fastening unit, or the locking sleeve may be slipping against the fastening unit and result in poor locking effect. Furthermore, the locking sleeve can only be adapted to the fastening units with hexagonal heads, and that limits the serviceable range of the locking sleeve.

Referring to FIG. 1 and FIG. 2, a conventional magnetic sleeve 1 is developed. The magnetic sleeve 1 includes a shank 11, a sleeve body 12 disposed at one end of the shank 11, a magnetic unit 13 disposed in the sleeve body 12, and a protection unit 14 wrapping the magnetic unit 13. The protection unit 14 is made of a soft material. The sleeve body 12 has a body 121, a hexagonal locking socket 122 recessed into the body 121, and a mounting hole 123 communicating with the hexagonal locking socket 122 for accommodating the magnetic unit 13. During a locking operation of a fastening unit with a hexagonal head (not shown), the hexagonal head is situated in the hexagonal locking socket 122 to allow the magnetic unit 13 to position the fastening unit via the magnetic force. Further, an outer force is applied on the shank 11 to carry out a rotation of the sleeve body 12 and drive the fastening unit to execute the locking operation.

Although the magnetic sleeve 1 can be adapted to drive the fastening unit with the hexagonal head, it can not be adapted to drive fastening units with different head types. Moreover, the magnetic unit 13 can attract and position the fastening unit via the magnetic force, but the magnetic unit 13 is exposed to the air for a long time, and that accelerates the oxidation of the magnetic unit 13. Thus, the magnetic force of the magnetic unit 13 is reduced quickly and the service life of the magnetic sleeve 1 is decreased. Further, a great quantity of metal chips produced during the locking operation may adhere to the magnetic unit 13 easily, and that affects the magnetic force of the magnetic unit 13 and reduces the locking effect of the magnetic sleeve 1, and that requires to be improved.

### SUMMARY OF THIS INVENTION

The object of this invention is to provide a locking sleeve capable of fixing fastening units with various head types stably to facilitate the locking operation, increase the convenience of use and attain stable locking effect.

The locking sleeve of this invention includes an inner sleeve and an outer sleeve sleevedly disposed on the inner sleeve. The inner sleeve has an inner body and a shank extending outwards from one end of the inner body. The outer sleeve has an outer body, a first end defined at one end of the outer body and adapted to accommodate the inner body, a second end defined at another end of the outer body and opposite to the first end, an engagement space enclosed by the outer body and penetrating through the first end and the second end, and a plurality of slots cutting into the outer body and extending from the second end to partition the outer body into a plurality of clamping portions with elasticity. Each clamping portion has an engagement unit formed on an edge of the clamping portion. During a locking operation, a head of a fastening unit is positioned in the engagement space and the engagement units clamp and engage the head to stably hold the fastening unit and fix the fastening unit speedily to thereby accelerate the following locking operation, increase the convenience of use, and attain stable locking effect.

Preferably, a first threaded portion is disposed on an outer periphery of the shank and a second threaded portion is disposed on an inner periphery of the inner body. The first threaded portion meshes with the second threaded portion to allow the shank to be engaged with the inner body.

Preferably, a driving unit extends from another end of the inner body.

Preferably, the inner body defines a room where the shank is inserted and a locking socket recessed into the inner body for accommodating the head of the fastening unit.

Preferably, a driving unit is configured to extend from the inner body and is disposed inside the locking socket.

Preferably, the locking socket is enclosed by a plurality of surrounding walls for accommodating the head of the fastening unit.

Preferably, each engagement unit has a sloping surface extending inwards from an edge of the second end and facing the engagement space.

Preferably, each engagement unit has a positioning surface joined to the sloping surface. Each engagement unit defines an imaginary reference line passing through a point where the positioning surface and the sloping surface are converged. The positioning surface is inclined to the imaginary reference line at a first angle. The sloping surface is inclined to the imaginary reference line at a second angle. The first angle of the positioning surface is different from the second angle of the sloping surface.

Preferably, a bearing is disposed between the inner sleeve and the outer sleeve to prevent the outer sleeve from taking action under a rotation of the inner sleeve driven by the shank.

Preferably, a limit unit is disposed on the first end of the outer sleeve to fix the bearing.

### BRIEF DESCRIPTION OF THE DRAWINGS

FIG. 1 is an exploded view showing a conventional magnetic sleeve;

FIG. 2 is a bottom plan view showing the installation of the magnetic unit of the conventional magnetic sleeve shown in FIG. 1;

FIG. 3 is an exploded view showing a first preferred embodiment of this invention;

FIG. 4 is an enlarged view of the encircled portion X indicated in FIG. 3;

FIG. 5 is a schematic view showing the operation of the first preferred embodiment of this invention;

FIG. 6 is a schematic view showing a second preferred embodiment of this invention characterized by the driving unit;

FIG. 7 is an exploded view showing a third preferred embodiment of this invention characterized by the locking socket;

FIG. 8 is a bottom plan view of the third preferred embodiment of this invention;

FIG. 9 is a schematic view showing the operation of the third preferred embodiment of this invention;

FIG. 10 is a schematic view showing a fourth preferred embodiment of this invention characterized by the locking socket and the driving unit; and

FIG. 11 is a schematic view of the fifth preferred embodiment of this invention characterized by the bearing.

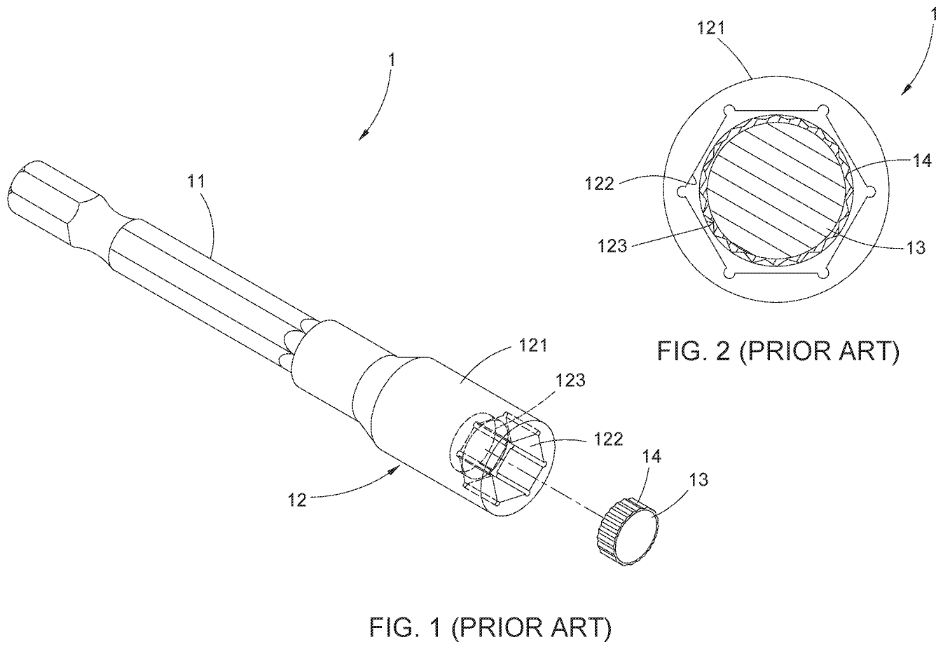

### DETAILED DESCRIPTION OF THE PREFERRED EMBODIMENTS

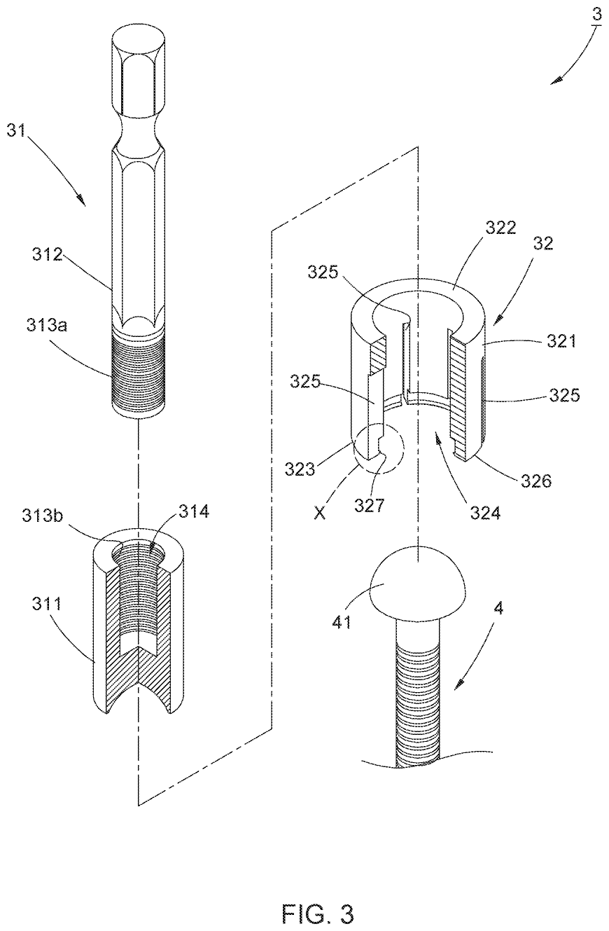

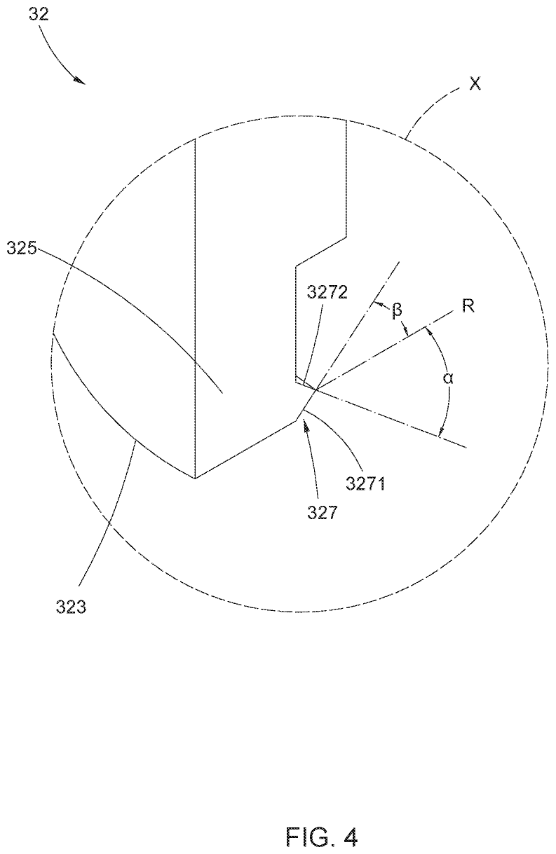

Referring to FIG. 3, a locking sleeve 3 of a first preferred embodiment of this invention comprises an inner sleeve 31 and an outer sleeve 32 sleevedly disposed on the inner sleeve 31. The inner sleeve 31 includes an inner body 311 and a shank 312 extending outwards from one end of the inner body 311. In this preferred embodiment, a first threaded portion 313a is disposed on an outer periphery of the shank 312, and a second threaded portion 313b is disposed on an inner periphery of the inner body 311. The shank 312 and the inner body 311 are engaged together when the first threaded portion 313a meshes with the second threaded portion 313b. Further, the inner body 311 defines a room 314 where the shank 312 is inserted. The outer sleeve 32 includes an outer body 321, a first end 322 defined at one end of the outer body 321 where the inner body 311 is inserted, a second end 323 defined at another end of the outer body 321 and opposite to the first end 322, an engagement space 324 enclosed by the outer body 321 and penetrating through the first end 322 and the second end 323, a plurality of slots 325 cutting into on the outer body 321 and extending from the second end 323 toward the first end 322 to divide the outer body 321 into a plurality of clamping portions 326 with elasticity, and an engagement unit 327 disposed on an edge of each clamping portion 326. In this preferred embodiment, each engagement unit 327 has a sloping surface 3271 extending inwards from an edge of the second end 323 and a positioning surface 3272 joined to the sloping surface 3271. Each engagement unit 327 defines an imaginary reference line R passing through a convergence of the positioning surface 3272 and the sloping surface 3271. The positioning surface 3272 is inclined to the imaginary reference line R at a first angle α. The sloping surface 3271 is inclined to the imaginary reference line R at a second angle β. The first angle α is larger than the second angle β.

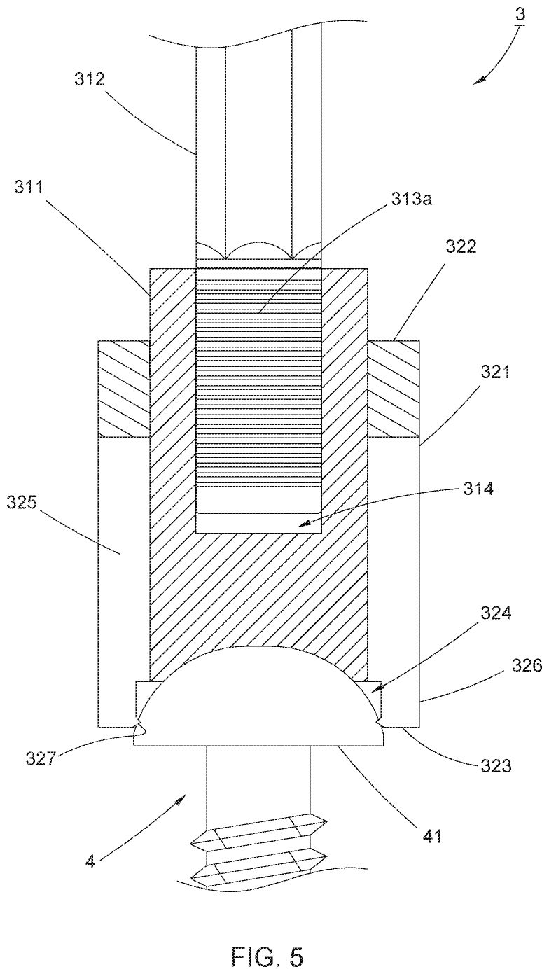

Referring to FIG. 3 and FIG. 5, during the installation of the locking sleeve 3, the shank 312 is inserted into the room 314 and engaged with the inner body 311 by meshing the first threaded portion 313a and the second threaded portion 313b together. The inner body 311 is inserted into the engagement space 324 via the first end 322 to allow the outer sleeve 32 to be sleevedly fitted on an outer periphery of the inner body 311. This preferred embodiment is aimed at executing a locking operation of a fastening unit 4 which has a head 41 formed to be a pan shape. In order to fit a shape of the head 41, an edge of another end of the inner body 311 is formed to be a curve shape. During the locking operation of the fastening unit 4, the second end 323 is covered on the head 41 to allow the engagement units 327 to contact with the head 41. A downward force is then applied on the locking sleeve 3 to press the outer sleeve 32 downwards. Since the slots 325 divide the outer body 321 into the clamping portions 326 and increase the elasticity of the outer body 321, the elasticity allows the head 41 to insert into the engagement space 324 smoothly and to be positioned by the edge of the inner body 311. Simultaneously, the engagement units 327 also clamp and engage the head 41 to fix the fastening unit 4 stably. A rotation force is then applied on the shank 312 to further carry out a rotation of the outer sleeve 32, and the fastening unit 4 is driven by the outer sleeve 32 to execute the locking operation. Thus, the fastening unit 4 will not be damaged during the locking operation. The elasticity allows the outer sleeve 32 to return to its original shape after deformation caused by the insertion of the fastening unit 4 without being damaged. Further, the locking sleeve 3 can fix the fastening unit 4 stably to thereby simplify and accelerate the following locking operation effectively, attain the preferable locking effect and increase the convenience of use.

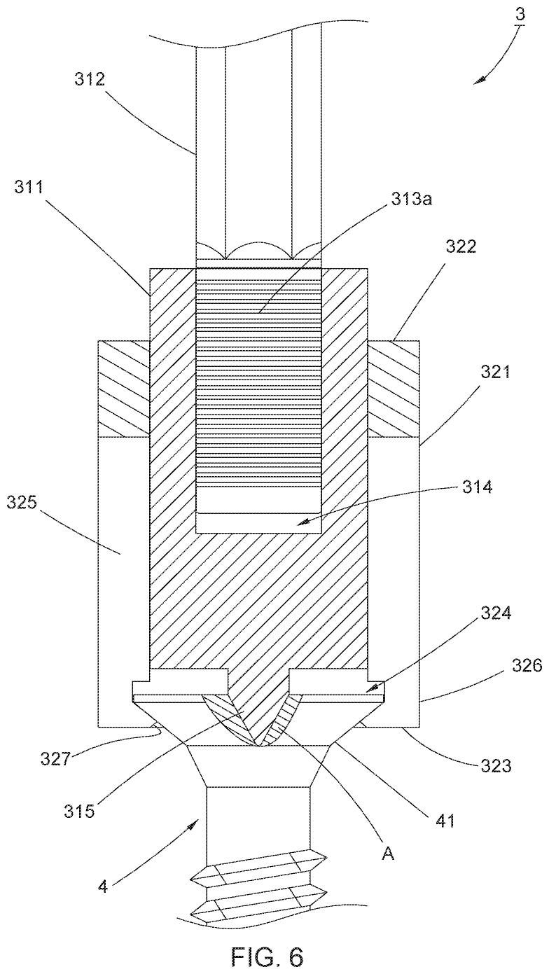

Referring to FIG. 6 shows a second preferred embodiment of the locking sleeve 3 of this invention. The correlated elements and the concatenation of elements, the operation and objectives of the second preferred embodiment are the same as those of the first preferred embodiment. This embodiment is characterized in that a driving unit 315 projects from another end of the inner body 311 and opposite to the shank 312. This preferred embodiment is aimed at executing a locking operation of a fastening unit 4 which has a head 41 formed to be a countersunk shape and a hole A recessed into the head 41. During the locking operation of the fastening unit 4, the second end 323 of the outer sleeve 32 is covered on the head 41 and a downward force is then applied to press the locking sleeve 3 downwards to further insert the driving unit 315 into the hole A. The engagement units 327 also clamp and engage the head 41 to fix the fastening unit 4 stably and the edge of the inner body 311 helps position the head 41 effectively to thereby accelerate the following locking operation.

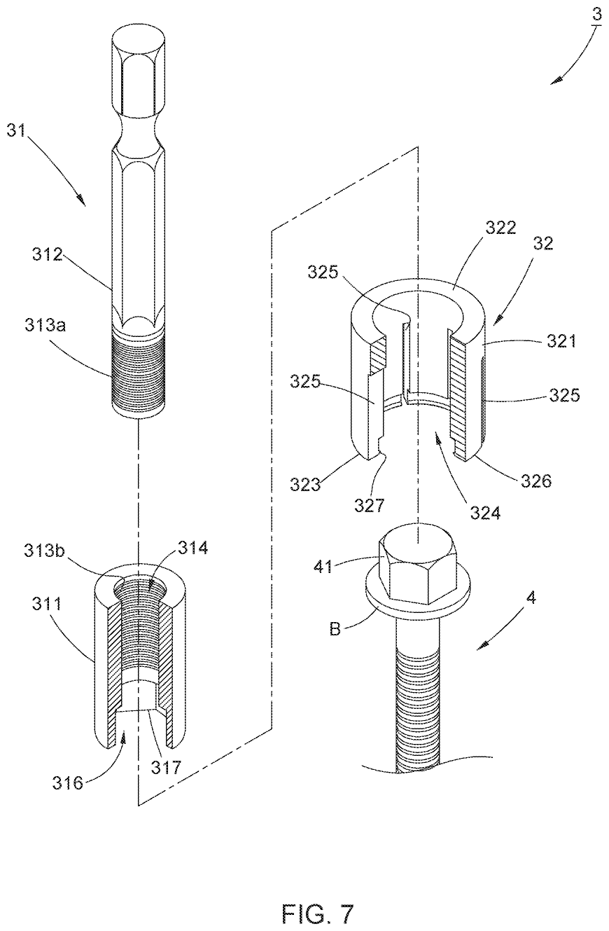

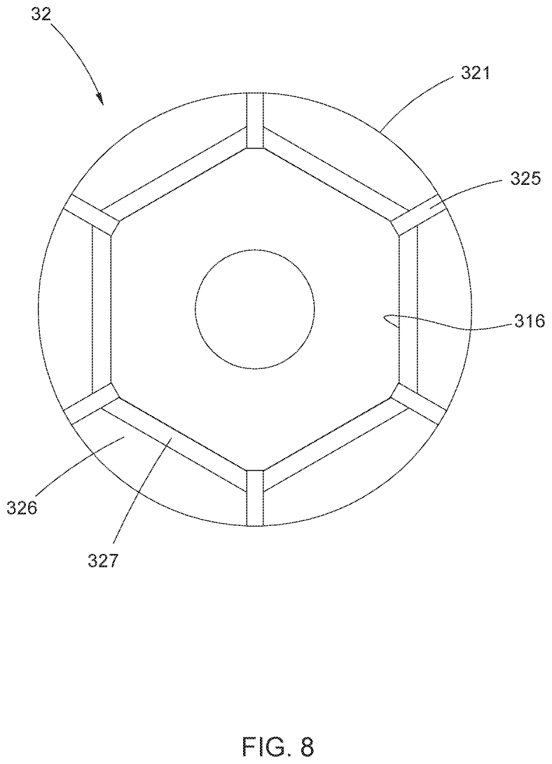

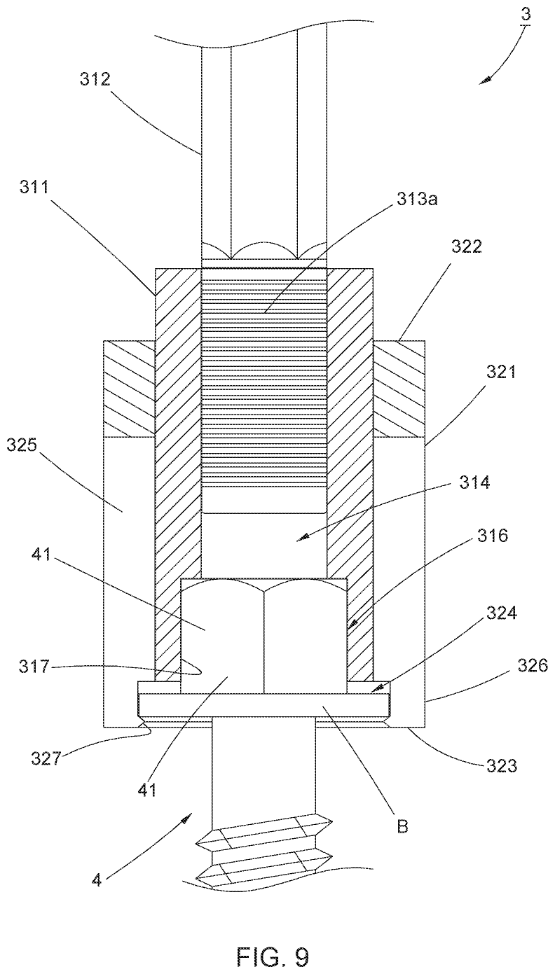

Referring to FIG. 7, FIG. 8 and FIG. 9 show a third preferred embodiment of the locking sleeve 3 of this invention. The correlated elements and the concatenation of elements, the operation and objectives of the third preferred embodiment are the same as those of the first preferred embodiment. This embodiment is characterized in that the inner body 311 defines a locking socket 316 recessed into the inner body 311. The locking socket 316 is enclosed by a plurality of surrounding walls 317. In this preferred embodiment, the locking socket 316 is formed to be a hexagonal shape. This preferred embodiment is aimed at executing a locking operation of a fastening unit 4 which has a head 41 formed to be a hexagonal shape and a washer B disposed under the head 41. The locking operation is executed by covering the second end 323 of the outer sleeve 32 on the head 41 and pressing the locking sleeve 3 downwards by a downward force to insert the head 41 into the engagement space 324 and further into the locking socket 316 to thereby accommodate the head 41 by the surrounding walls 317 and situate the washer B in the engagement space 324. Meanwhile, the engagement units 327 are situated under the washer B. Thus, the fastening unit 4 is positioned stably to thereby attain the smooth locking operation.

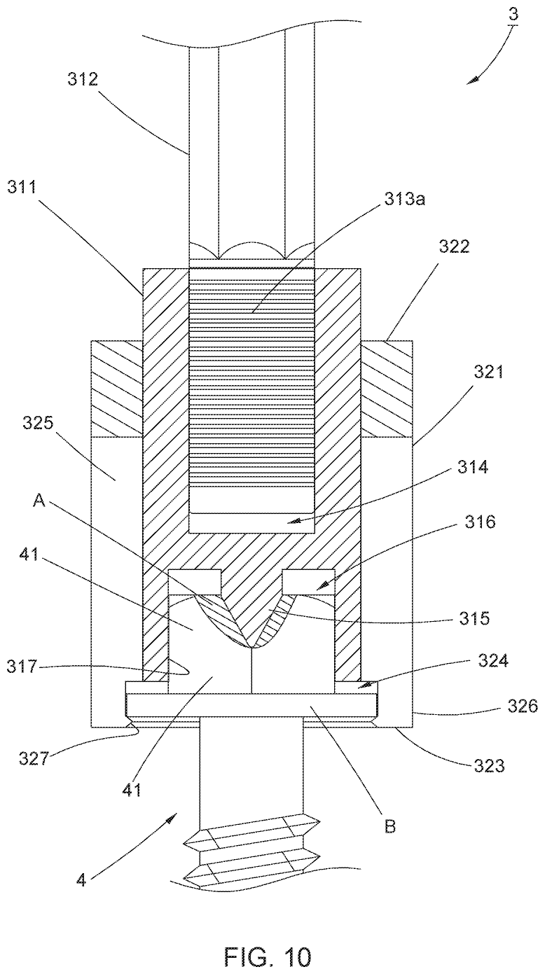

Referring to FIG. 10 shows a fourth preferred embodiment of the locking sleeve 3 of this invention. The correlated elements and the concatenation of elements, the operation and objectives of the fourth preferred embodiment are the same as those of the third preferred embodiment. This embodiment is characterized in that a driving unit 315 is configured to project from the inner body 311 and is disposed inside the locking socket 316. This preferred embodiment is aimed at executing a locking operation of a fastening unit 4 which has a head 41 formed to be a hexagonal shape, a hole A recessed into the head 41, and a washer B disposed under the head 41. During the locking operation, a downward force is applied to press the locking sleeve 3 after the second end 323 of the outer sleeve 32 is covered on the head 41 to allow the head 41 to insert into the locking socket 316 through the engagement space 324 and be positioned by the surrounding walls 317. Meanwhile, the driving unit 315 inserts into the hole A and the washer B is situated in the engagement space 324. Further, the engagement units 327 are situated under the washer B to thereby hold the washer B and the head 41 stably.

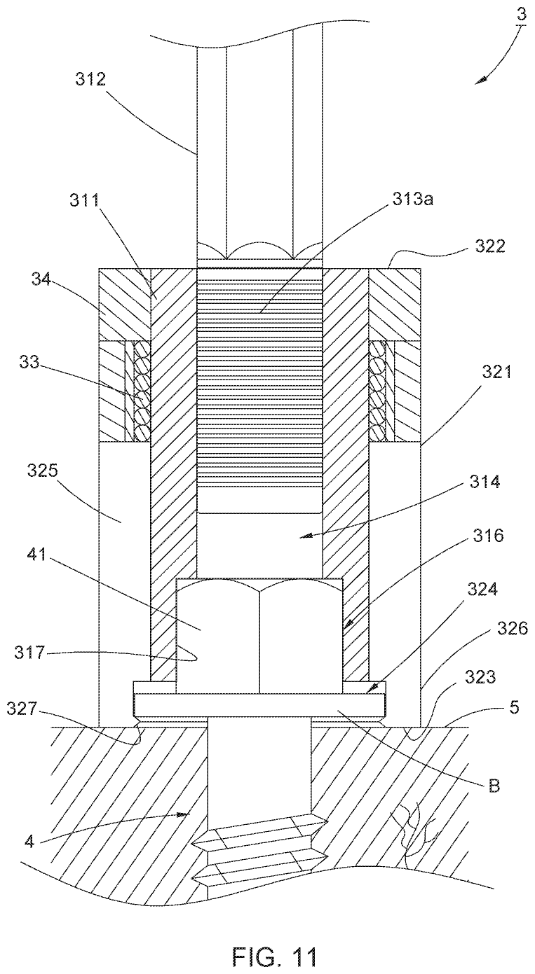

Referring to FIG. 11 shows a fifth preferred embodiment of the locking sleeve 3 of this invention. The correlated elements and the concatenation of elements, the operation and objectives of the fifth preferred embodiment are the same as those of the first preferred embodiment. This embodiment is characterized in that a bearing 33 is disposed between the inner sleeve 31 and the outer sleeve 32 and a limit unit 34 is disposed on the first end 322 of the outer sleeve 32 to fix the bearing 33. After the fastening unit 4 screws into an object 5 and the second end 323 of the outer sleeve 32 contacts with a surface of the object 5, the bearing 33 helps prevent the outer sleeve 32 from taking action under a rotation of the inner sleeve 31 driven by the shank 312. Thus, the outer sleeve 32 will not rub against the object 5 to thereby prevent the surface of the object 5 from being damaged. Hence, the locking effect is greatly increased.

To sum up, the locking sleeve of this invention takes advantages that the outer body is divided into the clamping portions by the slots to thereby increase the elasticity and prevent the outer body from being damaged by the insertion of the fastening unit. Meanwhile, the engagement units are capable of holding fastening units with various head types stably to thereby simplify and accelerate the locking operation effectively, increase the convenience of use, and achieve the preferable locking effect.

While the embodiments of this invention are shown and described, it is understood that further variations and modifications may be made without departing from the scope of this invention.

What is claimed is:

1. A locking sleeve comprising an inner sleeve and an outer sleeve sleevedly disposed on said inner sleeve;
wherein said inner sleeve includes an inner body and a shank extending outwards from one end of said inner body, said outer sleeve including an outer body, a first end defined at one end of said outer body and adapted to engage said inner body, a second end defined at another end of said outer body, an engagement space enclosed by said outer body and penetrating through said first end and said second end, and a plurality of slots cutting into said outer body and extending from said second end to divide said outer body into a plurality of clamping portions with elasticity, each of said plurality of clamping portions including an engagement unit disposed on an edge of said clamping portion for holding a fastening unit in position.

2. The locking sleeve according to claim 1, wherein a first threaded portion is disposed on an outer periphery of said shank, and a second threaded portion is disposed on an inner periphery of said inner body, said first threaded portion meshing with said second threaded portion to allow said shank to be engaged with said inner body.

3. The locking sleeve according to claim 1, wherein a driving unit projects from another end of said inner body.

4. The locking sleeve according to claim 1, wherein said inner body defines a room where said shank is inserted and a locking socket recessed into said inner body for accommodating a head of said fastening unit.

5. The locking sleeve according to claim 4, wherein a driving unit is configured to project from said inner body and is disposed inside said locking socket.

6. The locking sleeve according to claim 4, wherein said locking socket is enclosed by a plurality of surrounding walls for accommodating said head of said fastening unit.

7. The locking sleeve according to claim 1, wherein each of said plurality of engagement units of said outer body includes a sloping surface extending inwards from an edge of said second end and facing said engagement space.

8. The locking sleeve according to claim 7, wherein each of said plurality of engagement units of said outer body includes a positioning surface joined to said sloping surface, each of said plurality of engagement units defining an imaginary reference line passing through a point where said positioning surface and said sloping surface are joined, said positioning surface being inclined to said imaginary reference line at a first angle, said sloping surface being inclined to said imaginary reference line at a second angle, said first angle of said positioning surface being different from said second angle of said sloping surface.

9. The locking sleeve according to claim 1, wherein a bearing is disposed between said inner sleeve and said outer sleeve to prevent said outer sleeve from taking action under a rotation of said inner sleeve driven by said shank.

10. The locking sleeve according to claim 9, wherein a limit unit is disposed on said first end of said outer sleeve to fix said bearing.
